(19) United States
(12) Patent Application Publication
(10) Pub. No.: US 2014/0375810 A1
(43) Pub. Date: Dec. 25, 2014

(54) VEHICULAR SAFETY METHODS AND ARRANGEMENTS

(71) Applicant: Digimarc Corporation, Beaverton, OR (US)

(72) Inventor: Tony F. Rodriguez, Portland, OR (US)

(21) Appl. No.: 14/309,738

(22) Filed: Jun. 19, 2014

Related U.S. Application Data
(60) Provisional application No. 61/837,808, filed on Jun. 21, 2013.

(51) Int. Cl. G06K 9/00; B60Q 5/00

(52) U.S. Cl. CPC G06K 9/00791; B60Q 5/006
USPC 348/148

(57) ABSTRACT

In accordance with one aspect of the present technology, a driver's inattention is communicated to other drivers, so that they may take appropriate defensive measures. Examples of measures that may be taken include increasing a distance from the inattentive driver, and driving so as to avoid the need for sudden braking or other abrupt action. Many other features and arrangements are also detailed.

### CROSS-REFERENCE TO RELATED APPLICATIONS

This application claims the benefit of U.S. Provisional Application No. 61/837,808, filed Jun. 21, 2013, the contents of which is herein incorporated by reference.

### TECHNICAL FIELD

The present technology concerns vehicular technology, including arrangements for sensing information about a driver's inattentiveness, and communicating safety information to vehicle occupants.

### BACKGROUND AND INTRODUCTION

There were 32,367 traffic deaths in the U.S. in 2011. Many of these deaths were due to drivers who were dozing, distracted, or otherwise inattentive.

Much work has been focused on this problem, and a variety of useful technologies have been developed. Among these are technologies for sensing a driver's inattention, so that an alarm or other stimulus can be provided to the driver to prompt the driver to re-focus attention on the road. Examples include the following arrangements (these papers are provided in an appendix):
Barr, et al, A review and evaluation of emerging driver fatigue detection measures and technologies, National Transportation Systems Center, 2005;
Batista, et al, A drowsiness and point of attention monitoring system for driver vigilance, IEEE Intelligent Transportation Systems Conference, 2007, pp. 702-708;
Batista, et al, A real-time driver visual attention monitoring system, In Pattern Recognition and Image Analysis, pp. 200-208, 2005;
Bergasa, et al, Real-time system for monitoring driver vigilance, IEEE Trans. on Intelligent Transportation Systems, Vol. 7.1 (2006), pp. 63-77;
Dong, et al, Driver inattention monitoring system for intelligent vehicles—A review, IEEE Trans. on Intelligent Transportation Systems, Vol. 12(2), pp. 596-614;
Doshi, et al, On the roles of eye gaze and head dynamics in predicting driver's intent to change lanes, IEEE Trans on Intelligent Transportation Systems, Vol. 10(3), pp. 453-462;
Ji, et al, Real-Time Eye, Gaze, and Face Pose Tracking for Monitoring Driver Vigilance, Real-Time Imaging 8 (2002), pp. 357-377;
Smith, et al, Determining driver visual attention with one camera, IEEE Trans. on Intelligent Transportation Systems, Vol. 4(4), 205-218, 2003;
Tran, et al, Vision for Driver Assistance: Looking at People in a Vehicle, Chapter 30 in Guide to Visual Analysis of Humans: Looking at People, Springer, Moeslund, et al, eds., 2011; and
Wang, et al, Driver fatigue detection—a survey, 6th IEEE World Conference on Intelligent Control and Automation, 2006.

In accordance with one aspect of the present technology, a driver's inattention is communicated to other drivers, so that they may take appropriate defensive measures. These measures may include increasing a distance from the inattentive driver, and driving so as to avoid the need for sudden braking or other abrupt action.

The foregoing and other features and advantages will be more readily apparent from the following detailed description, which proceeds with reference to the accompanying drawings.

### BRIEF DESCRIPTION OF THE DRAWINGS

FIG. 1 shows a sequence of three vehicles.

FIG. 2 is a block diagram showing an illustrative vehicle that is equipped to practice aspects of the present technology.

### DETAILED DESCRIPTION

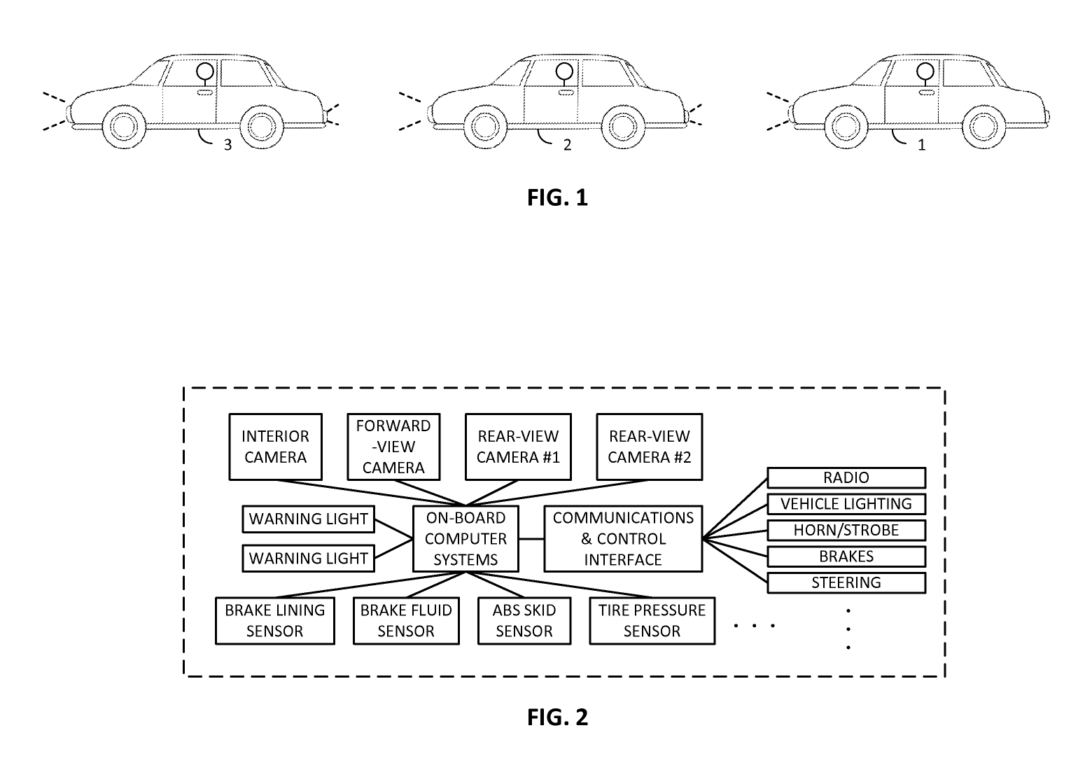

Referring to FIG. 1, a sequence of three moving vehicles is shown. Each vehicle includes headlights and other lighting (denoted, e.g., by the dashed lines extending from the front of each vehicle). At least one vehicle includes a rear-facing camera (denoted by the dashed lines extending from the back of vehicles 2 and 3).

The rear-facing camera of vehicle 2 captures imagery of a driver of vehicle 1. This imagery is analyzed, yielding information about the attentiveness of that driver. An alert can then be issued to a driver of vehicle 2, based on this information. This alert can be audible (e.g., an voice annunciation that a following driver is inattentive), visual (e.g., display of an icon or text indicating potential danger from the car behind, presented on the vehicle dashboard, or with a heads-up display on the vehicle windshield, or on a head-worn display), tactile (e.g., using an actuator coupled to the steering wheel or seat), or otherwise.

Any of the techniques detailed in the above-referenced papers can be used to sense the first driver's inattentiveness. A particularly preferred embodiment analyzes the imagery to track a gaze of the first driver. If the gaze falls from a looking-at-the-road ahead state (e.g., if the driver's head nods when dozing, or looks down to read or send a text message on a mobile phone), corresponding information is communicated to other drivers.

The imagery that is analyzed to determine the driver's attentiveness may be captured by a camera in the first vehicle, rather than a rear-facing camera in the second vehicle. This imagery may be analyzed in the first vehicle, and the results can broadcast to other nearby vehicles, e.g., by short-range wireless broadcast such as WiFi, Bluetooth or Zigbee. Alternatively, the imagery may be streamed from the first vehicle to a remote processor (e.g., a “cloud” processor), which analyzes the data for signs of inattentiveness, and then issues alerts to vehicles that are determined to be near the first vehicle. Known location-based-services can be used to push such information to vehicles that are determined to be close to the first vehicle (e.g., within 25, 100, or 300 feet).

One short-range communication technique employs modulation of the first vehicle's headlights and/or other exterior lighting to communicate information (e.g., inattentiveness alarms) to nearby vehicles. That is, the headlights of the first vehicle may be driven by an excitation voltage that includes a small pulse-width modulated component, which encodes a digital message signaling an inattentiveness alarm. Such modulation may be apparent to human observers or not, but a compliant optical receiver in other vehicles can decode the message from the subtle luminance variations. (In some arrangements, chrominance modulation can be employed.) Such optical receivers include one or more photosensors that sense such illumination. Existing vehicle cameras (e.g., a rear-facing “back-up” camera) can be used for this photo-sensing purpose.

(Optical signaling for inter-vehicle communication, e.g., using LED headlamps, is further detailed in application Ser. No. 13/888,939, filed May 7, 2013.)

While radio communication is desirable in many situations, LED communication tends to be more privacy-preserving.

As indicated, a common embodiment involves a rear-facing camera in the second vehicle, whose field of view includes the driver of the first vehicle. This imagery may be analyzed in that second vehicle, or it may be streamed to the cloud for analysis. Again, responsive alarm information can be broadcast from the second vehicle, or pushed from the cloud server.

Headlights on this second vehicle can be modulated, e.g., as described above, to relay information about the danger posed by the first vehicle, to a third vehicle that is ahead of the second. In like fashion, the alarm can be further relayed to fourth and additional vehicles. In addition, tail lights on the second vehicle can be modulated to communicate an alarm back to the first vehicle, so that its inattentive driver may be alerted.

The information conveyed to other vehicles can include information about the location of the dangerous vehicle, e.g., whether it is immediately following, or more remote in traffic. This location information can be expressed in terms of distance. Distance can be determined using GPS data, or it can be ascertained by non-GPS techniques—such as radar and laser ranging. Another is for vehicles to routinely emit identification signals using both sound (e.g., ultrasonic) and radio signals. The time delay between arrival of these two signals at any point serves to identify the distance between that point and the emitting vehicle. Still another technology by which the locations and relative spacings of vehicles can be determined is detailed in Digimarc's U.S. Pat. Nos. 8,463,290, 8,451,763, 8,421,675, 7,983,185, and 7,876,266, and copending application Ser. No. 13/892,079, filed May 10, 2013. (The location of a first vehicle, and the locations of other vehicles as determined by that first vehicle, can be among the information communicated to other vehicles, e.g., by the first vehicle.)

Desirably, a communications exchange between vehicles includes an acknowledgement that is sent from a receiving vehicle back to the originating vehicle, to confirm that the receiving vehicle has decoded a message. In the example just-given, where inattentiveness is sensed in imagery captured by a second vehicle, and signaled back to the offending first vehicle, if an acknowledgement is not promptly received from the first vehicle, another signal can be sent.

One such signal is a loud sound issued by the second vehicle, such as a horn blast, attempting to re-focus the driver of the first vehicle back onto the road. Another is a rear-facing strobe light that is flashed from the second vehicle—again to try and restore the attention of the driver in the vehicle behind.

In addition to the attentiveness of the first driver, the present principles can be used to communicate other information between vehicles. These include warnings that one or more vital vehicle systems are not operating within safe parameters (e.g., brakes, tire pressure, lighting, etc.). If the vehicle's onboard computer detects any anomalous behavior or condition in such system(s)—such as might cause a warning light on the vehicle's dashboard to be illuminated—this fact should be communicated to nearby vehicles.

Similarly, environmental information can be exchanged between vehicles. This includes whether antilock braking is activated in a vehicle (indicating slippery conditions); whether acceleration or deceleration exceeds normal (threshold) values; whether a driver is about to perform a lane-change (as indicated by an eye-tracking or head-tracking module that watches the driver and notes the driver looking to the side or over their shoulder); whether hazard flashers are activated (hopefully other drivers notice them, but at a minimum, surrounding vehicles should be alerted to them so their drivers can be redundantly alerted); and whether signals are being received from a law enforcement speed-sensing (where lawful).

While the foregoing discussion has assumed that vehicle 2 is controlled by a human operator, it is expected that many vehicles will be partially- or fully-controlled by computer systems. Google's work is conspicuous in this field, but many universities and corporations—and DARPA—have done a great deal of work on such technology. The artisan is presumed to be familiar with publications detailing such work. (Among these are U.S. Pat. Nos. 8,457,827, 6,971,464, 6,459,965, 6,151,539, 6,085,131 and 20110184605.) The present technology is well-suited for use in such systems, e.g., with alerts issued to the control system of the vehicles.

It will be recognized that some embodiments of the present technology form an ad hoc network of neighboring vehicles, who exchange sensor and other state information to the benefit of all.

FIG. 2 is a block diagram showing an illustrative vehicle that is equipped to practice aspects of the present technology. This vehicle is equipped with four video cameras. One is inside the passenger compartment and views the driver. Its imagery is analyzed for signs of driver inattentiveness or fatigue. Two rear-view cameras are provided. Imagery from one or both can be analyzed for hazards, e.g., inattentiveness of a driver in a following vehicle, or that vehicle's erratic driving. The two cameras may have different fields of view and/or different focal plane(s) and/or different apertures/exposure intervals. Different fields of view allow, e.g., one camera to alert the driver of back-up hazards, such as a child playing close behind the car, while the other camera captures imagery of a following vehicle, and its driver. Different focal planes allow resolution of subjects at widely varying distances—beyond the depth of focus of a single camera in dim lighting. Different apertures/exposure intervals allow one camera to sense imagery in the presence of bright illumination, while the other is adapted for poor illumination—without the momentary blindness that arises when a single camera has to switch between such lighting conditions. If analysis of video from any of these cameras suggests a hazardous condition, a corresponding alert can be issued to the vehicle's driver (and/or vehicle control system), as well as to drivers/control systems of nearby vehicles.

Some implementations employ 3D sensing technology, such as a ranging sensor (e.g., the Microsoft Kinect device), a time of flight (TOF) camera, stereoscopic cameras, a plenoptic camera (e.g., the Lytro device), etc., to provide additional information (e.g., distance) for threat analysis.

The FIG. 2 vehicle also includes a multitude of sensors to monitor status of various vehicle components. Only a few are depicted. Others include, e.g., a sensor that detects unburned oxygen in the vehicle exhaust, a sensor indicating the fuel tank is approaching empty, collision avoidance sensors, seatbelt sensors, brake pedal sensor, throttle valve sensor, battery temperature sensor, airbag sensors, turn signal switch, speed sensor, cruise control settings, impact sensors, lane-sensing cameras for adaptive cruise control, etc. The vehicle also includes a smaller number of warning lights on the dashboard, to visually alert the driver in response to signals from a sub-set of these sensors. The full-range of sensor data, however, can be streamed to surrounding vehicles, to apprise them of the vehicle's operating conditions. Or alert signals can be issued to other vehicles only if a sensor indicates a value beyond a threshold value (e.g., a nearby vehicle who is exceeding the posted speed limiting by 10 mph or more), or a change in value at a rate beyond a threshold value (e.g., a driver two cars ahead in traffic is hitting the brake pedal strongly), or a circumstance otherwise outside of nominal conditions. This latter circumstance may be, e.g., that the driver of a vehicle has unfastened the driver's seatbelt—portending a reach into the backseat or other distracting activity, or that a lane sensing camera in a nearby vehicle indicates that the driver is drifting out of a lane, yet the vehicle's turn signal is not on—perhaps evidencing a problem.

In some embodiments, video data sensed by a camera in one vehicle is sent to other vehicles. This can permit, e.g., vehicle 1 in FIG. 3 to see the view ahead of vehicle 3. Such imagery can be presented to the driver of vehicle 1, or can be analyzed by a computer system to identify potential hazards upcoming to vehicle 1. If presented to a driver, a heads-up projection of the video imagery on the windshield can be employed—allowing the driver to monitor the view far ahead without taking eyes off the view immediately ahead.

The depicted vehicle also includes a communications and control interface. This interface attends to data exchange with other vehicles, and—for autonomous and semi-autonomous vehicles—attends to control of different vehicle systems.

Speaking of autonomous vehicle control, road signs can be inexpensively adapted to communicate with vehicle systems through use of digital watermark encoding. By such technology, data about the sign (e.g., its text, location, issuing authority, etc.) can be encoded in the signage artwork, without any evidence of data encoding being conspicuous to human observers. A camera in the vehicle captures imagery of the vehicle's environment, including the sign. The imagery is provided to a digital watermark detector, which examines the imagery for the presence of any steganographic data encoding. If found, the data is decoded, and provided to one or more of the vehicle's on-board computer systems as control instructions or input data.

Alternatively, signs can communicate to vehicles by radio or optical data transmission. One such implementation equips a sign with an RFID chip, which can be interrogated by an RFID reader in a nearby vehicle. When interrogated, the chip emits an identifier, which can include bits identifying the sign message (e.g., most significant bits 011 may indicate a Stop sign). The car computer system can consult a data repository—within the vehicle or in the cloud—to obtain further information about the sign using part or all of the identifier (e.g., the sign's full text or location).

In addition to serving as input data for autonomous vehicle operation (e.g., “Stop”), signage data can also serve as input by which behavior of vehicles, as unsafe, can be discerned. For example, after vehicle 2 stops and then passes through a stop-signed intersection (sensing the stop sign in the process), it may then sense vehicle 1 continuing past that location without slowing or stopping. This evidences a distracted or otherwise unsafe driver, and the occupants of vehicle 2 can be alerted.

Digimarc's U.S. Pat. Nos. 7,340,076 and 7,506,169 concern use of digital watermarking in signage and other vehicle applications. Digital watermark technology is more generally detailed in Digimarc's U.S. Pat. Nos. 6,590,996, 6,912,295, and 20100150434. Watermarks take up no “visual real state” on the sign area, and can be applied (e.g., painted or screened) after other printing has been applied. Reflective inks, metameric inks, and other special colors can be employed.

Watermarks are deterministic—allowing each sign to have a unique identity. This avoids confusion inherent in text-recognition and other pattern-recognition approaches to sign detection, which treat all Stop signs as equivalent, etc. Moreover, sign watermarks can be encrypted with a private key, and decrypted with a corresponding public key, so spoofing can be eliminated. For example, only signs encoded by the US Department of Transportation would decode with the USDOT's public key.

### Concluding Remarks

Having described and illustrated the principles of the inventive work with reference to illustrative examples, it will be recognized that the technology is not so limited.

For example, while the foregoing embodiments employed fixed cameras for sensing inattentiveness and other hazards, other cameras can be used. For example, a mobile phone may be holstered, while driving, in a bracket that provides it a camera view out the rear windshield. (Many phones have both forward- and rear-facing cameras.) Other aspects of the system—such as analyzing the imagery and issuing a warning of an inattentive driver—can similarly be implemented using the smartphone (e.g., as a smartphone app).

Particularly contemplated smartphones include the Apple iPhone 5; smartphones following Google's Android specification (e.g., the Galaxy S III phone, manufactured by Samsung, the Motorola Droid Razr HD Maxx phone, and the Nokia N900), and Windows 8 mobile phones (e.g., the Nokia Lumia 920).

Alternatively, the technology can be implemented using one or more of the processors built into the vehicle. And, as noted, some of the processing may be performed by a remote, cloud, processor.

More generally, processes and system components detailed in this specification may be implemented as instructions for computing devices, including general purpose processor instructions for a variety of programmable processors, including microprocessors (e.g., the Intel Atom, the ARM A5, the Qualcomm Snapdragon, and the nVidia Tegra 4; the latter includes a CPU, a GPU, and nVidia's Chimera computational photography architecture), graphics processing units (GPUs, such as the nVidia Tegra APX 2600, and the Adreno 330—part of the Qualcomm Snapdragon processor), and digital signal processors (e.g., the Texas Instruments TMS320 and OMAP series devices), etc. These instructions may be implemented as software, firmware, etc. These instructions can also be implemented in various forms of processor circuitry, including programmable logic devices, field programmable gate arrays (e.g., the Xilinx Virtex series devices), field programmable object arrays, and application specific circuits—including digital, analog and mixed analog/digital circuitry. Execution of the instructions can be distributed among processors and/or made parallel across processors within a device or across a network of devices. Processing of data may also be distributed among different processor and memory devices. References to “processors,” “modules” or “components” should be understood to refer to functionality, rather than requiring a particular form of implementation.

Software instructions for implementing the detailed functionality can be authored by artisans without undue experimentation from the descriptions provided herein, e.g., written in C, C++, Visual Basic, Java, Python, Tel, Perl, Scheme, Ruby, etc., in conjunction with associated data.

Software and hardware configuration data/instructions are commonly stored as instructions in one or more data structures conveyed by tangible media, such as magnetic or optical discs, memory cards, ROM, etc., which may be accessed across a network. Some embodiments may be implemented as embedded systems—special purpose computer systems in which operating system software and application software are indistinguishable to the user (e.g., as is commonly the case in basic cell phones). The functionality detailed in this specification can be implemented in operating system software, application software and/or as embedded system software.

The present technology can be practiced or used in connection with wearable computing systems, including headworn devices. Such devices typically include a camera and display technology by which computer information can be viewed by the user—either overlaid on the scene in front of the user (sometimes termed augmented reality), or blocking that scene (sometimes termed virtual reality), or simply in the user's peripheral vision. Exemplary technology is detailed in U.S. Pat. No. 7,397,607, 20100045869, 20090322671, 20090244097 and 20050195128. Commercial offerings, in addition to the Google Glass product, include the Vuzix Smart Glasses M100, Wrap 1200AR, and Star 1200XL systems. An upcoming alternative is augmented reality contact lenses. Such technology is detailed, e.g., in patent document 20090189830 and in Parviz, Augmented Reality in a Contact Lens, IEEE Spectrum, September, 2009. Some or all such devices may communicate, e.g., wirelessly, with other computing devices (carried by the user or otherwise), or they can include self-contained processing capability. Likewise, they may incorporate other features known from existing smart phones and patent documents, including electronic compass, accelerometers, gyroscopes, camera(s), projector(s), GPS, etc. Such arrangements can be used both to sense a driver's inattentiveness (either the driver wearing the headworn apparatus, or another driver), and to communicate warnings to the driver (e.g., visual or audio).

Applicant's other patent documents that contain teachings relevant to the present technology include 20110161076, 20110212717, 20120284012, and pending application Ser. No. 13/750,752, filed Jan. 25, 2013.

This specification has discussed various embodiments. It should be understood that the methods, elements and concepts detailed in connection with one embodiment can be combined with the methods, elements and concepts detailed in connection with other embodiments. While some such arrangements have been particularly described, many have not—due to the large number of permutations and combinations. Applicant similarly recognizes and intends that the methods, elements and concepts of this specification can be combined, substituted and interchanged—not just among and between themselves, but also with those known from the cited prior art. Moreover, it will be recognized that the detailed technology can be included with other technologies—current and upcoming—to advantageous effect. Implementation of such combinations is straightforward to the artisan from the teachings provided in this disclosure.

While this disclosure has detailed particular ordering of acts and particular combinations of elements, it will be recognized that other contemplated methods may re-order acts (possibly omitting some and adding others), and other contemplated combinations may omit some elements and add others, etc.

Although disclosed as complete systems, sub-combinations of the detailed arrangements are also separately contemplated (e.g., omitting various of the features of a complete system).

While certain aspects of the technology have been described by reference to illustrative methods, it will be recognized that apparatuses configured to perform the acts of such methods are also contemplated as part of applicant's inventive work. Likewise, other aspects have been described by reference to illustrative apparatus, and the methodology performed by such apparatus is similarly within the scope of the present technology. Still further, tangible computer-readable media containing instructions for configuring a processor or other programmable system to perform such methods is also expressly contemplated.

The present specification should be read in the context of the cited references. Those references disclose technologies and teachings that applicant intends be incorporated into embodiments of the present technology, and into which the technologies and teachings detailed herein be incorporated.

To provide a comprehensive disclosure, while complying with the statutory requirement of conciseness, applicant incorporate-by-reference each of the documents referenced herein. (Such materials are incorporated in their entireties, even if cited above in connection with specific of their teachings.) These references disclose technologies and teachings that can be incorporated into the arrangements detailed herein, and into which the technologies and teachings detailed herein can be incorporated. The reader is presumed to be familiar with such prior work.

In view of the wide variety of embodiments to which the principles and features discussed above can be applied, it should be apparent that the detailed embodiments are illustrative only, and should not be taken as limiting the scope of the invention. Rather, applicant claims all such modifications as may come within the scope and spirit of the following claims and equivalents thereof.

What is claimed is:

1. A method comprising:
capturing imagery of a driver of a first car;
analyzing the imagery, said analysis yielding information about the attentiveness of the driver; and
issuing an alert to a driver of a second car based on said information.

2. The method of claim 1 in which said analysis comprises tracking a gaze of said driver of the first car.

3. The method of claim 1 in which the second car is ahead of the first car.

4. The method of claim 1 that includes capturing said imagery using a camera of the first car.

5. The method of claim 1 that includes capturing said imagery using a rear-facing camera of the second car.

6. The method of claim 5 that further includes alerting a driver of a third car based on said information.

7. The method of claim 6 in which the third car is ahead of the second car.

8. The method of claim 6 wherein said alerting comprises transmitting data from the second car to the third car.

9. The method of claim 8 wherein said transmitting includes transmitting said data using a headlight of the second car.

10. The method of claim 1 that further includes alerting the driver of the first car based on said information.

11. The method of claim 10 wherein said alerting comprises flashing a rear-facing light of the second car.

12. A method comprising:
receiving imagery captured by a camera of a first car, the received imagery depicting a driver of a second car;
analyzing the imagery to determine the attentiveness of the driver; and
broadcasting an alert to a driver of the first car based on said analysis.

13. The method of claim 12 wherein the first car is ahead of the second car.

14. The method of claim 12, wherein analyzing the imagery comprises analyzing the imagery at the first car.

15. The method of claim 12, wherein broadcasting the alert comprises broadcasting the alert from the first car.

16. A vehicular safety system for a car, the system comprising:
a camera;
a processor coupled to the camera; and
a memory coupled to the processor, the memory containing instructions for configuring the processor to perform acts including:
analyzing imagery captured by the camera, said analysis yielding information about the attentiveness of a driver of a neighboring vehicle; and
issuing an alert to a driver of the car based on said information.
